(19) United States
(12) Patent Application Publication
(10) Pub. No.: US 2025/0001725 A1
(43) Pub. Date: Jan. 2, 2025

(54) GLASS CLOTH COMPOSITE MATERIAL

(71) Applicant: Shin-Etsu Chemical Co., Ltd., Tokyo (JP)

(72) Inventors: Toshio SHIOBARA, Tokyo (JP); Ryo TANAKA, Annaka-shi (JP)

(73) Assignee: Shin-Etsu Chemical Co., Ltd., Tokyo (JP)

(21) Appl. No.: 18/734,948

(22) Filed: Jun. 5, 2024

(30) Foreign Application Priority Data
Jun. 23, 2023 (JP) 2023-102885

(51) Int. Cl. B32B 5/26; B32B 5/02

(52) U.S. Cl. CPC B32B 5/265; B32B 5/022; B32B 2250/20; B32B 2260/023; B32B 2260/046; B32B 2262/101; B32B 2262/106; B32B 2307/7242

(57) ABSTRACT

Provided is a glass cloth fiber composite material having both an excellent electromagnetic wave shielding property and an excellent impact resistance, and is also superior in handling property since the material is a composite of a carbon nanotube unwoven cloth and a glass cloth, and employs no strongly acidic compound as being, for example, a protonating agent. The glass cloth composite material comprises one or more glass cloth layers and one or more carbon nanotube unwoven cloth layers, wherein at least one of the glass cloth and carbon nanotube unwoven cloth layers in the glass cloth composite material is impregnated with a heat-curable resin or has a heat-curable resin film laminated thereon.

### BACKGROUND OF THE INVENTION

### Field of the Invention

The present invention relates to a glass cloth composite material; particularly to a glass cloth composite material having an electromagnetic wave shielding property and an excellent impact resistance, which is suitable for use in, for example, high-speed communication devices employing millimeter waves, terahertz-band electromagnetic waves or the like, lighter-weight vehicles intended to reduce carbon dioxide emission and improve fuel consumption efficiency, and connected cars.

### Background Art

Conventionally, fiber-reinforced composite materials composed of reinforcing fibers and matrix resins have been used in many fields such as those of aerospace, automobile vehicles, railroad vehicles, vessels, civil engineering and construction, and sporting goods, as being light and superior in mechanical properties such as strength and rigidity, heat resistance, and corrosion resistance.

Further, in the field of automobile vehicles or the like, as electrification advances and for the sake of further improvement in fuel consumption accordingly, fiber-reinforced composite materials are now required to ensure a compatibility between impact resistance and further reduction in weight.

Moreover, in recent years, studies are being made on how to put high-speed communication such as 5G and 6G utilizing millimeter waves and terahertz-band electromagnetic waves to practical use in the days ahead.

Wireless devices that use electromagnetic waves for communication are increasing, and the ever-increasing electromagnetic waves pose a risk that electronic devices may malfunction due to interference from electromagnetic waves from their surroundings and/or a risk that they may leak information via electromagnetic waves emitted by themselves. There are now more wireless devices using electromagnetic waves for communication; the ever-increasing electromagnetic waves shall lead to a risk of malfunction as a result of having an electronic device interfered with by the electromagnetic waves therearound, and a risk of information leakage due to the electromagnetic waves the electronic device emits in and of itself. Further, in order to propel the rapidly advancing technology of automated driving of vehicles or the like, transmission and reception of electromagnetic waves have to take place properly under various electromagnetic environments ranging from low-frequency electromagnetic waves to millimeter waves.

In this regard, developing an electromagnetic wave shielding measure has become a critical technical challenge, where desired is an electromagnetic wave shielding material having a superior electromagnetic wave shielding capability with respect to micro, millimeter and terahertz waves. Sophistication of electromagnetic wave use has also led to higher needs for novel functions of an electromagnetic wave shielding material, such as a smaller film thickness, a reduced weight and a larger area thereof.

As for resin-impregnated glass cloth-reinforced composite materials employing glass cloth as reinforcing fibers, since they are lighter than metals, the materials are being considered as substitutes for metals in improving fuel consumption efficiency of electric vehicles and so on, and have been put to practical use in certain areas.

However, since these resin-impregnated glass cloth-reinforced composite materials have an unsatisfactory toughness as compared to metals and exhibit no electromagnetic wave shielding property, there is a limitation in their use as vehicle body structural materials for, in particular, an autonomous vehicle.

As electromagnetic wave shielding materials, there have been proposed many electromagnetic wave shielding techniques using not only metal materials but also carbon black, graphene, carbon nanotubes, electrically conductive polymers and dielectric oxides. Particularly, carbon nanotubes made of carbon have gained attention as a prospective electromagnetic wave shielding material.

As electromagnetic wave shielding materials using carbon nanotubes, there are known, for example, a paste material with carbon nanotubes being dispersed in a resin (JP-A-2009-144000), and an aqueous paint with carbon nanotubes being dispersed in an aqueous solution (JP-A-2012-174833); each of these materials is difficult to handle and does not have a sufficient electromagnetic wave shielding capability, which makes them unfit for use at practical level. Since the carbon nanotubes used in these materials are in a fine fibrous form, the large surface area thereof prevents them from being dispersed in a resin by a large amount, which causes such electromagnetic wave shielding materials using carbon nanotubes to also exhibit an insufficient electric conductivity.

Further, there is known an electromagnetic wave shielding material using a carbon nanotube sheet formed via charge spinning (JP-A-2008-218859); the problem with this material is that it is difficult to handle due to its poor strength.

There is also disclosed an electromagnetic wave shielding material that has had its conductivity improved by adding a protonating agent such as hydronium ions and hydrochloric acid to a carbon nanotube sheet, and further adding a ferromagnetic material such as iron and/or cobalt thereto (Japanese Patent No. 6182176); the handling of this material is problematic as the protonating agent is a strongly acidic compound.

### SUMMARY OF THE INVENTION

Thus, it is an object of the present invention to provide a glass cloth fiber composite material that has both an excellent electromagnetic wave shielding property and an excellent impact resistance, and is superior in handling property without employing any strongly acidic compound as being, for example, a protonating agent.

The inventors of the present invention diligently conducted a series of studies to solve the aforementioned problems, and completed the invention by finding that the glass cloth composite material described below was able to achieve the above object.

That is, the present invention is to provide the following glass cloth composite material.

[1] A glass cloth composite material comprising:
one or more glass cloth layers; and
one or more carbon nanotube unwoven cloth layers,
wherein at least one of the glass cloth and carbon nanotube unwoven cloth layers in the glass cloth composite material is impregnated with a heat-curable resin or has a heat-curable resin film laminated thereon.

[2] The glass cloth composite material according to [1], comprising:
one or more layers of a heat-curable resin-containing glass cloth prepreg
   with a glass cloth being impregnated with a heat-curable resin or
   with a heat-curable resin film being laminated on a glass cloth; and
one or more layers of a heat-curable resin-containing carbon nanotube unwoven cloth prepreg
   with a carbon nanotube unwoven cloth being impregnated with a heat-curable resin or
   with a heat-curable resin film being laminated on a carbon nanotube unwoven cloth.

[3] The glass cloth composite material according to [2], wherein a ratio of [number of layers of heat-curable resin-containing glass cloth prepreg/number of layers of heat-curable resin-containing carbon nanotube unwoven cloth prepreg] in the glass cloth composite material is 0.1 to 5.0.

[4] The glass cloth composite material according to any one of [1] to [3], wherein the carbon nanotube unwoven cloth is an unwoven cloth composed of multi-walled carbon nanotubes alone, single-walled carbon nanotubes alone, or a mixture of multi-walled carbon nanotubes and single-walled carbon nanotubes.

[5] The glass cloth composite material according to any one of [1] to [4], wherein the carbon nanotube unwoven cloth is a carbon nanotube unwoven cloth with a multi-walled carbon nanotube and a single-walled carbon nanotube being laminated together.

[6] The glass cloth composite material according to any one of [1] to [5], wherein the carbon nanotube unwoven cloth has a thickness of not larger than 1 mm, an air permeability of not larger than 0.5 cm³/cm²·s, and a specific resistance of not larger than 0.005 Ω·cm.

The glass cloth composite material of the present invention has both an excellent electromagnetic wave shielding property and an excellent impact resistance, and is also superior in handling property since the material is a composite of a carbon nanotube unwoven cloth and a glass cloth, which employs no strongly acidic compound as being, for example, a protonating agent. Thus, the glass cloth composite material of the present invention is a material suitable for use in high-speed communication devices utilizing electromagnetic waves in high-frequency bands having frequencies that are as high as or higher than those of millimeter waves, and is also useful as a vehicle body structural material or in-vehicle material enabling weight reduction and fuel consumption reduction since the material itself is light.

### DETAILED DESCRIPTION OF THE INVENTION

The present invention is described in detail hereunder.

A glass cloth composite material of the present invention has one or more glass cloth layers and one or more carbon nanotube unwoven cloth layers, where at least one of the glass cloth and carbon nanotube unwoven cloth layers in this glass cloth composite in material is impregnated with a heat-curable resin or has a heat-curable resin film laminated thereon.

### <Glass Cloth>

The glass cloth as used herein refers to a woven cloth that is fabricated using glass fibers. It is preferred that the glass fiber contains a SiO₂ content of at least 50 to 100% by mass, a Al₂O₃ content of at least 0 to 30% by mass and a CaO content of at least 0 to 30% by mass. It is particularly preferred that the fiber be composed of at least one type of glass selected from the group consisting of T glass, D glass, E glass, NE glass and quartz glass. Among them, it is more preferred in terms of general versatility that the type of glass composing the glass fibers be the E glass. It is also more preferred in terms of high strength and low-thermal expansion property that the type of glass be the T glass or the quartz glass.

In the present invention, the metallic oxide compositions of the T glass, D glass, E glass, NE glass and quartz glass are as defined below.

The T glass refers to a glass with a composition that contains a SiO₂ content of 62 to 65% by mass, a Al₂O₃ content of 20 to 25% by mass, a CaO content of 0 to 0.01% by mass, a MgO content of 10 to 15% by mass, a B₂O₃ content of 0 to 0.01% by mass and a total content of Na₂O and K₂O of 0 to 1% by mass.

The D glass refers to a glass with a composition that contains a SiO₂ content of 72 to 76% by mass, a Al₂O₃ content of 0 to 5% by mass, a CaO content of 0 to 1% by mass, a MgO content of 0 to 1% by mass, a B₂O₃ content of 20 to 25% by mass and a total content of Na₂O and K₂O of 3 to 5% by mass.

The E glass refers to a glass with a composition that contains a SiO₂ content of 52 to 56% by mass, a Al₂O₃ content of 12 to 16% by mass, a CaO content of 15 to 25% by mass, a MgO content of 0 to 6% by mass, a B₂O₃ content of 5 to 10% by mass and a total content of Na₂O and K₂O of 0 to 0.8% by mass.

The NE glass refers to a glass with a composition that contains a SiO₂ content of 52 to 56% by mass, a Al₂O₃ content of 10 to 15% by mass, a CaO content of 0 to 10% by mass, a MgO content of 0 to 5% by mass, a B₂O₃ content of 15 to 20% by mass, a total content of Na₂O and K₂O of 0 to 1% by mass and a TiO₂ content of 0.05 to 5% by mass.

The quartz glass refers to a glass with a composition that contains a SiO₂ content of 99.0 to 100%.

It is preferred that the glass fibers have the tensile strength of, although not limited to the following, not less than 30 N/25 mm, more preferably not less than 45 N/25 mm in the longitudinal direction when the fibers are in the form of glass cloth. Such fibers can produce a prepreg that is excellent in terms of size stability and impact strength property. The tensile strength in the longitudinal direction is a value measured in accordance with JIS R3420 by subjecting the glass cloth to a constant-rate-of-extension tensile strength tester. The term “longitudinal direction” as used in the measurement of the tensile strength refers to the direction of warp yarn (vertical yarn).

It is preferred that the glass cloth has a thickness of 10 to 200 μm, more preferably of 10 to 140 μm, and even more preferably of 20 to 100 μm although the thickness is not limited to these ranges. The glass cloth having such thickness allows a resin composition to be favorably impregnated into the glass cloth while allowing itself to have a low profile.

It is preferred that the glass cloth has an air permeability of 1 to 80 cm³/cm²·s, more preferably of 3 to 50 cm³/cm²·s although the rate is not limited to these ranges. The air permeability below 1 cm³/cm²·s may deteriorate impregnating ability of a resin composition into the glass cloth while the rate exceeding 80 cm³/cm²·s may decrease the tensile strength or result in variations in the tensile strength.

The glass cloth can be obtained by weaving the glass cloth with warp and weft yarns using a loom which is known per se after subjecting them to the fiber spreading treatment. Examples of the loom may include jet looms such as air jet or water jet looms, shuttle looms, and rapier looms. Examples of weaving techniques using a loom include, for example, plain weaving, satin weaving, mat weaving and twill weaving. The weaving structure of glass cloth is not specifically restricted, but in terms of excellent properties such as strength, smoothness, and resin impregnation, plain weave structure is preferred.

Examples of the fiber spreading technique include spreading by water jet pressure, spreading by high-frequency vibration using a liquid as a medium, spreading by the pressure of a fluid having a surface pressure, and spreading by roll pressing. Among these spreading techniques, the spreading by water jet pressure or the spreading by high-frequency vibration using a liquid as a medium may be preferably used because variations in the width of each of the warp yarns or the weft yarns after the spreading process can be reduced. The spreading process may employ a plurality of spreading techniques to prevent defects in the appearance of the glass cloth, such as bowed filling, which is attributable to the spreading process.

### <Carbon Nanotube Unwoven Cloth>

The carbon nanotube unwoven cloth used in the present invention is one with single and/or multi-walled carbon nanotube fibers having a diameter of not larger than 50 nm and a length of not larger than 2 mm, preferably 10 to 500 μm being intertwined with one another; the unwoven cloth itself preferably has a thickness of not larger than 1 mm. The carbon nanotube unwoven cloth used in the present invention may be one in which the carbon nanotube fibers are composed of single-walled carbon nanotubes; one in which the carbon nanotube fibers are composed of multi-walled carbon nanotubes; or one in which the carbon nanotube fibers are composed of both single- and multi-walled carbon nanotubes in a mixed manner. In addition, the carbon nanotube unwoven cloth may be one in which multi-walled carbon nanotubes and single-walled carbon nanotubes are laminated together. Further, the carbon nanotube unwoven cloth may be one with a multi-walled carbon nanotube unwoven cloth and a single-walled carbon nanotube unwoven cloth being laminated together.

It is preferred that the carbon nanotube unwoven cloth used in the present invention have a basis weight of 1 to 1,000 g/m², more preferably 2 to 500 g/m², even more preferably 5 to 100 g/m². It is preferable if the carbon nanotube unwoven cloth have a basis weight of not smaller than 1 g/m², because there will be exhibited a high mechanical strength, and an excellent impact resistance and electromagnetic wave-shielding property. Further, it is preferable if the carbon nanotube unwoven cloth have a basis weight of not larger than 1,000 g/m², because there will be exhibited an excellent balance between electromagnetic wave-shielding property and flexibility.

For the sake of improving electric conductivity, preferred is a highly conductive carbon nanotube unwoven cloth having an air permeability of not larger than 0.5 cm³/cm²·s, and a specific resistance of not larger than 0.005 Ω·cm, preferably not larger than 0.003 Ω·cm.

The carbon nanotube unwoven cloth is one prepared by intertwining carbon nanotube fibers obtained by known methods, such as carbon nanotube fibers spun by a plasma furnace using a hydrocarbon gas such as a methane gas, and carbon nanotube fibers spun through a fine hole after dissolving carbon nanotubes.

Air permeability can be adjusted by for example pressurizing the carbon nanotube unwoven cloth, where the intertwinement of the carbon nanotube fibers and the thickness of the carbon nanotube unwoven cloth are adjusted. In this specification, air permeability is a value of an air permeability of the cloth that is measured by a Frazier type tester in accordance with JIS R 3420.

A carbon nanotube unwoven cloth preferably having an air permeability of not larger than 0.5 cm³/cm²·s, more preferably not larger than 0.1 cm³/cm²·s, even more preferably not larger than 0.05 cm³/cm²·s is preferable as it also has a favorable electric conductivity and exhibits an excellent electromagnetic wave shielding performance in a wide range of frequencies (10 kHz to 300 GHz).

As a carbon nanotube unwoven cloth having the abovementioned characteristics, there may, for example, be listed the following commercially available products.

### (1) CNTM10 by Tortech Nano Fibers

Thickness 32 μm, Air permeability 0.04 cm³/cm²·s, Specific resistance 2.22E-03 (Ω·cm)

### (2) CNTM30 by Tortech Nano Fibers

Thickness 78 μm, Air permeability 0.01 cm³/cm²·s, Specific resistance 1.51E-03 (Ω·cm)

(3) MIRALON (registered trademark) by Huntsman Corporation

Thickness 20 μm, Air permeability 0.05 cm³/cm²·s, Specific resistance 3.5E-03 (Ω·cm)

(4) Single-walled carbon nanotube unwoven cloth by MEIJO NANO CARBON Co., Ltd.

Thickness 50 μm, Air permeability 0.01 cm³/cm²·s, Specific resistance 1.82E-04 (Ω·cm)

### <Heat-Curable Resin>

As a heat-curable resin serving as a binder of the glass cloth and/or the carbon nanotube unwoven cloth, there may be employed a heat-curable resin(s) selected from the group consisting of an epoxy resin, a phenolic resin, an allylated epoxy resin, an allylated polyphenylene ether resin, a maleimide resin, a bismaleimide resin, a cyanate resin, a cyclopentadiene-styrene copolymer resin, a silicone resin, an acrylic resin, and a polyester resin.

Particularly, as the heat-curable resin used in the present invention, preferred are one or more kinds of resins selected from the epoxy resins, bismaleimide resins and cyanate ester resins as explained below.

Such epoxy resin is preferably exemplified by an epoxy resin having at least two glycidyl groups per molecule.

Examples of favorable epoxy resin used in the present invention include bisphenol-type epoxy resins such as a bisphenol A-type epoxy resin, a bisphenol F-type epoxy resin, a bisphenol AD-type epoxy resin, and a bisphenol S-type epoxy resin; biphenyl frame-containing epoxy resins; naphthalene frame-containing epoxy resins; dicyclopentadiene frame-containing epoxy resins; novolac-type epoxy resins such as a phenol novolac-type epoxy resin and a cresol novolac-type epoxy resin; polyfunctional epoxy resins; glycidyl amine-type epoxy resins such as N,N,O-triglycidyl-m-aminophenol, N,N,O-triglycidyl-p-aminophenol, N,N,O-triglycidyl-4-amino-3-methylphenol, N,N,N′,N′-tetraglycidyl-4,4′-methylenedianiline, N,N,N′,N′-tetraglycidyl-2,2′-diethyl-4,4′-methylenedi aniline, N,N,N′,N′-tetraglycidyl-m-xylylenediamine, N,N-diglycidylaniline, and N,N-diglycidyl-o-toluidine; resorcinol diglycidyl ether; and triglycidyl isocyanurate.

Any one of these epoxy resins may be used alone, or multiple of them may be used in a mixed manner.

If using an epoxy resin as the heat-curable resin, it is preferred that there also be used a curing agent for epoxy resin; as such curing agent for epoxy resin, any curing agent may be used so long as it is a curing agent having active hydrogen-containing phenolic hydroxyl groups or amino groups, and forming crosslinked structures with epoxy resins. As a phenolic hydroxyl group-containing curing agent, there may be used a curing agent of any structure so long as it is a phenolic hydroxyl group-containing phenolic resin. As an amino group-containing curing agent, preferred is an aromatic amine curing agent with which there can be obtained an epoxy resin cured product having a high heat resistance and a high elastic modulus. Specific examples of such aromatic amine curing agent include solid aromatic amine curing agents such as 4,4′-diaminodiphenylmethane, 3,3′-diaminodiphenylsulfone, 4,4′-diaminodiphenylsulfone, 3,3′-diisopropyl-4,4′-diaminodiphenylmethane, 3,3′-di-t-butyl-4,4′-diaminodiphenylmethane, 3,3′-diethyl-5,5′-dimethyl-4,4′-diaminodiphenylmethane, 3,3′-di-t-butyl-5,5′-dimethyl-4,4′-diaminodiphenylmethane, 3,3′,5,5′-tetraethyl-4,4′-diaminodiphenylmethane, 3,3′-diisopropyl-5,5′-diethyl-4,4′-diaminodiphenylmethane, 3,3′-di-t-butyl-5,5′-diethyl-4,4′-diaminodiphenylmethane, 3,3′-di-t-butyl-5,5′-diisopropyl-4,4′-diaminodiphenylmethane, 3,3′,5,5′-tetra-t-butyl-4,4′-diaminodiphenylmethane, and 3,3′,5,5′-tetramethyl-4,4′-diaminodiphenylmethane; 2,2′-diethyldiaminodiphenylmethane; diethyltoluenediamines such as 2,4-diethyl-6-methyl-m-phenylenediamine and 4,6-diethyl-2-methyl-m-phenylenediamine; liquid aromatic amine curing agents such as 4,4′-methylenebis(N-methylaniline), 4,4′-methylenebis(N-ethylaniline), 4,4′-methylenebis(N-sec-butylaniline), and N,N′-di-sec-butyl-p-phenylenediamine; or mixtures of solid and liquid aromatic amine curing agents.

Among them, particularly preferred are 3,3′-diaminodiphenylsulfone, 4,4′-diaminodiphenylsulfone, 3,3′-diisopropyl-4,4′-diaminodiphenylmethane, 3,3′,5,5′-3,3′-diisopropyl-5,5′-diethyl-4,4′-tetramethyl-4,4′-diaminodiphenylmethane, diaminodiphenylmethane, and 3,3′,5,5′-tetraethyl-4,4′-diaminodiphenylmethane.

The phenolic hydroxyl group-containing phenolic resin is added in an amount at which the molar equivalent of the phenolic hydroxyl groups will preferably be 0.1 to 2.0, more preferably 0.2 to 1.8, particularly preferably 0.4 to 1.5, per 1 molar equivalent of the epoxy groups contained in the epoxy resin(s). When such equivalent is smaller than 0.1, unreacted epoxy groups will remain, which may impair adhesion; when such equivalent is larger than 2.0, unreacted phenolic hydroxyl groups will remain, which may lead to a deterioration in strength when stored under a high temperature.

Further, the aromatic amine curing agent is added in an amount at which the equivalent of all the amino groups in the aromatic amine curing agent(s) will preferably be 0.7 to 1.5, more preferably 0.7 to 1.2, even more preferably 0.7 to 1.1, particularly preferably 0.85 to 1.05, per 1 molar equivalent of the epoxy groups.

When such equivalent is smaller than 0.7, unreacted epoxy groups will remain, which may lead to a lowered glass-transition temperature or an impaired adhesion; when such equivalent is larger than 1.5, the cured product will become hard and brittle so that cracks may occur at the time of performing reflow or undergoing temperature cycles.

One kind of curing agent for epoxy resin may be used alone, or two or more kinds thereof may be used in combination.

As the bismaleimide resin, preferred is a bismaleimide resin represented by the following formula (1) or (2) as being superior in heat resistance, low elasticity, toughness and adhesion.

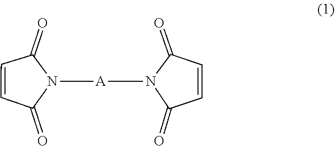

In the formula (1), the symbol A represents a dimer acid frame-derived hydrocarbon group.

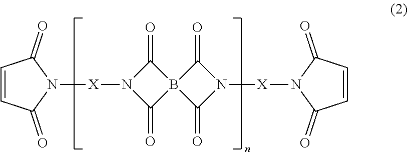

In the formula (2), B independently represents a tetravalent organic group having a cyclic structure; X independently represents a divalent hydrocarbon group having 6 to 200 carbon atoms, where at least one X represents a dimer acid frame-derived hydrocarbon group; n is 1 to 100.

A dimer acid refers to a liquid dibasic acid whose main component is a dicarboxylic acid having 36 carbon atoms, which is produced by dimerizing an unsaturated fatty acid having 18 carbon atoms and employing a natural substance such as a vegetable fat or oil as its raw material; a dimer acid may contain multiple structures as opposed to one single type of frame, and there exist several types of isomers. Typical dimer acids are categorized under the names of linear type, monocyclic type, aromatic ring type, and polycyclic type. In this specification, a dimer acid frame refers to a group induced from a dimer diamine having a structure established by substituting the carboxy groups in a dimer acid with primary aminomethyl groups. A dimer acid frame-derived hydrocarbon group may be expressed as —C₃₆H₇₀-in terms of an average structure thereof.

A typical example of the bismaleimide resin of the formula (1) may be SLK-6895 produced by Shin-Etsu Chemical Co., Ltd.

In the formula (2), B independently represents a tetravalent organic group having a cyclic structure; particularly, it is preferred that B be any one of the tetravalent organic groups represented by the following structural formulae.

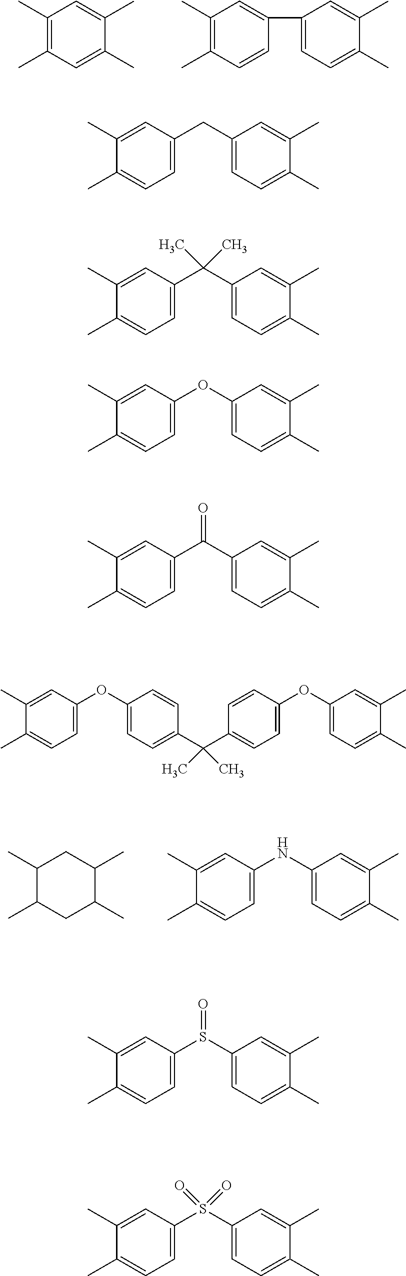

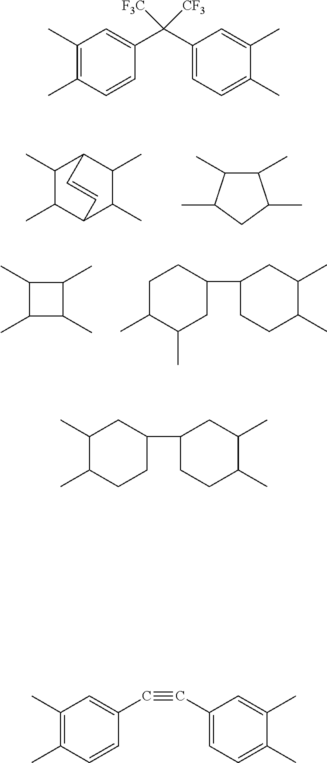

Bonds in the above structural formulae that are yet unbonded to substituent groups are to be bonded to carbonyl carbons forming cyclic imide structures in the formula (2).

Further, in the formula (2), X independently represents a divalent hydrocarbon group having 6 to 200, preferably 8 to 100, more preferably 10 to 50 carbon atoms. Particularly, it is preferred that X be a branched divalent hydrocarbon group with at least one hydrogen atom in the above divalent hydrocarbon group being substituted by an alkyl or alkenyl group(s) having 6 to 200, preferably 8 to 100, more preferably 10 to 50 carbon atoms. The branched divalent hydrocarbon group may be either a saturated aliphatic hydrocarbon group or an unsaturated hydrocarbon group, and may also have an alicyclic structure or an aromatic ring structure in the midway of the molecular chain.

At least one X in the formula (2) represents a dimer acid frame-derived hydrocarbon group (such as —C₃₆H₇₀—).

In the formula (2), n is 1 to 100, preferably 1 to 60, more preferably 1 to 50. When n is too large, a solubility and fluidity will be impaired, which may then impair a moldability such as lamination and impregnation properties.

A typical example of the bismaleimide resin of the formula (2) may be a bismaleimide resin represented by the following formula (4) (SLK-3000 produced by Shin-Etsu Chemical Co., Ltd.):

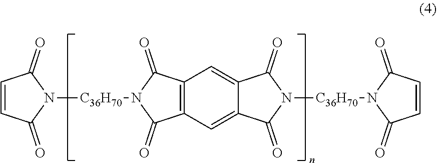

where n≈5 (Average value).

One kind of each of the bismaleimide resins represented by the formulae (1) and (2) may be used alone, or two or more kinds thereof may be used in combination.

Other than the SLK-6895 (by Shin-Etsu Chemical Co., Ltd.) and the SLK-3000 (by Shin-Etsu Chemical Co., Ltd.), typical examples of the bismaleimide resin may also include the SLK-2000 series (by Shin-Etsu Chemical Co., Ltd.).

It is preferred that the bismaleimide resin has a number average molecular weight (Mn) of 300 to 50,000, more preferably of 500 to 30,000, and even more preferably of 600 to 10,000.

The term “number average molecular weight (Mn)” as used herein refers to a weight-average molecular weight (Mn) measured by the gel permeation chromatography (GPC) under the following conditions using polystyrene as a standard substance.

### [GPC Measurement Conditions]

Developing solvent: Tetrahydrofuran (THF)
Flow rate: 0.35 mL/min
Detector: Differential refractive index detector (RI)
Column: TSK Guardcolumn SuperH-L
   TSKgel SuperHZ4000 (4.6 mm I.D.×15 cm×1)
   TSKgel SuperHZ3000 (4.6 mm I.D.×15 cm×1)
   TSKgel SuperHZ2000 (4.6 mm I.D.×15 cm×2)
(All manufactured by Tosoh Corporation)
Column temperature: 40° C.
Sample injection volume: 5 μL (THF solution with a concentration of 0.2% by mass)

If using a bismaleimide resin as the heat-curable resin, it is preferred that there also be used, as a curing catalyst, a reaction initiator for bismaleimide resin. There are no particular restrictions on such reaction initiator for bismaleimide resin so long as it is capable of promoting a crosslinking reaction, examples of which may include ionic catalysts such as imidazoles, an organic phosphorus-based compound, tertiary amines, quaternary ammonium salts, a boron trifluoride-amine complex, organophosphines, and an organophosphonium salt; organic peroxides such as diallyl peroxide, dialkyl peroxide, peroxide carbonate, and hydroperoxide; and radical polymerization initiators such as azoisobutyronitrile.

Particularly, an organic peroxide is preferred, examples of which may include dicumyl peroxide, t-butyl peroxybenzoate, t-amyl peroxybenzoate, dibenzoyl peroxide, dilauroyl peroxide, 2,5-dimethyl-2,5-di(t-butylperoxy) hexane, 1,1-di(t-butylperoxy) cyclohexane, di-t-butyl peroxide, and dibenzoyl peroxide.

The reaction initiator is preferably added in an amount of 0.05 to 10 parts by mass, more preferably 0.1 to 5 parts by mass, per 100 parts by mass of the bismaleimide resin(s).

One kind of such reaction initiator may be used alone, or two or more kinds thereof may be used in combination.

The cyanate ester resin is a cyanate ester compound having at least two cyanato groups per molecule.

A commonly known compound may be used as such cyanate ester compound having at least two cyanato groups per molecule; a cyanate ester compound represented by the following formula (5) is preferred.

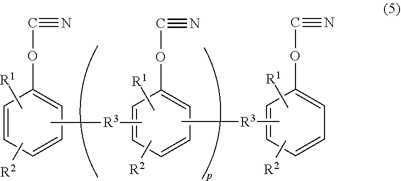

In the formula (5), each of R¹s and R²s independently represents a hydrogen atom or an alkyl group having 1 to 4 carbon atoms; each R³ independently represents a divalent linking group selected from the group consisting of those represented by the following formulae; p is a number satisfying p=0 to 10.

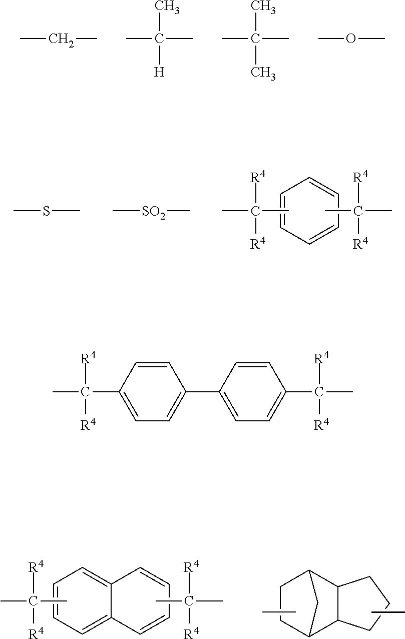

Each R⁴ in the above formulae independently represents a hydrogen atom or a methyl group.

Specific examples of the cyanate ester resin include the following cyanate ester compounds. For example, there may be listed bis(4-cyanatophenyl)methane, bis(3-methyl-4-cyanatophenyl)methane, bis(3,5-dimethyl-4-cyanatophenyl)methane, 1,1-bis(4-cyanatophenyl)ethane, 2,2-bis(4-cyanatophenyl) propane, 1,3-dicyanatobenzene, 1,4-dicyanatobenzene, 2-tert-butyl-1,4-dicyanatobenzene, 2,4-dimethyl-1,3-dicyanatobenzene, 2,5-di-tert-butyl-1,4-dicyanatobenzene, tetramethyl-1,4-dicyanatobenzene, 1,3,5-tricyanatobenzene, 2,2′-dicyanatobiphenyl, 4,4′-3,3′,5,5′-tetramethyl-4,4′-dicyanatobiphenyl, 1,3-dicyanatobiphenyl, dicyanatonaphthalene, 1,4-dicyanatonaphthalene, 1,5-dicyanatonaphthalene, 1,6-dicyanatonaphthalene, 1,8-dicyanatonaphthalene, 2,6-dicyanatonaphthalene, 2,7-dicyanatonaphthalene, 1,3,6-tricyanatonaphthalene, bis(4-cyanatophenyl)ether, 4,4′-(1,3-phenylenediisopropylidene)diphenylcyanate, bis(4-cyanatophenyl)thioether, tris(4-cyanato-phenyl)phosphine, a bisphenol E-type cyanate ester, a phenol novolac-type cyanate, a cresol novolac-type cyanate, bis(3-ethyl-4-cyanatophenyl)methane, bis(4-cyanatophenyl)sulfone, 1,1,1-tris(4-cyanatophenyl)ethane, 2,2-bis(4-cyanatophenyl)-1,1,1,3,3,3-hexafluoropropane, a diallyl bisphenol A-type cyanate ester, a diallyl bisphenol F-type cyanate ester, a biphenyl aralkyl-type cyanate ester, a dicyclopentadiene novolac-type cyanate, a naphthalene ring-containing cyanate ester, an aralkyl-type cyanate ester, and a heterocyclic cyanate ester. There may be used one kind of these cyanate ester compounds, or two or more kinds of them may be used in a mixed manner. Particularly, preferable cyanate ester compounds are bis(4-cyanatophenyl)methane, bis(3-methyl-4-cyanatophenyl)methane, 1,1-bis(4-cyanatophenyl)ethane, and a phenol novolac-type cyanate ester. More preferable cyanate ester compounds are 1,1-bis(4-cyanatophenyl)ethane and a phenol novolac-type cyanate ester. Further, one kind of such cyanate ester compound may be used alone, or multiple kinds thereof may be used in combination.

It is preferable if the viscosity of the cyanate ester compound is not higher than 300 Pa's at room temperature, because a cyanate ester compound having such viscosity has an excellent fluidity and an excellent impregnation property with respect to the glass cloth and carbon nanotube unwoven cloth, which allows curing to take place in a uniform manner easily.

Here, the viscosity of the cyanate ester compound is a value measured by a B-type rotary viscometer at room temperature (23 to 30° C.) in accordance with a method described in JIS K7117-1:1999.

If using a cyanate ester resin as the heat-curable resin, it is preferred that there also be used a curing agent for cyanate ester resin. There may be used any curing agent for cyanate ester resin so long as it is capable of reacting with a cyanate ester compound; a commonly known curing agent such as a phenolic curing agent may be used.

Examples of such phenolic curing agent include a phenol novolac resin, a naphthalene ring-containing phenolic resin, an aralkyl type-phenolic resin, a triphenolalkane-type phenolic resin, a biphenyl frame-containing aralkyl-type phenolic resin, a biphenyl-type phenolic resin, an alicyclic phenolic resin, a heterocyclic phenolic resin, a resorcinol-type phenolic resin, an allyl group-containing phenolic resin, and a bisphenol-type phenolic resin such as a bisphenol A-type resin and a bisphenol F-type resin.

One kind of such curing agent for cyanate ester resin can be used alone, or two or more kinds thereof may be used in combination.

The phenolic curing agent is preferably added in an amount of 0.5 to 20 parts by mass, more preferably 1 to 10 parts by mass, per 100 parts by mass of the cyanate ester resin.

Further, there may also be used in combination a commonly known curing accelerator to promote curing of the cyanate ester resin. The curing accelerator may, for example, be a phosphorus-based compound, a tertiary amine compound, an imidazole compound and the like. One kind of such curing accelerator may be used alone, or two or more kinds thereof may be used in combination. The curing accelerator is preferably added in an amount of 0.1 to 10 parts by mass, more preferably 0.2 to 5.5 parts by mass, per 100 parts by mass of the cyanate ester resin.

### <Heat-Curable Resin-Containing Glass Cloth Prepreg>

The heat-curable resin-containing glass cloth prepreg composing the glass cloth composite material of the present invention is one with the glass cloth being impregnated with the heat-curable resin or with a heat-curable resin film being laminated on such glass cloth; preferably one with the glass cloth being impregnated with at least one kind of heat-curable resin selected from the epoxy resin, bismaleimide resin and cyanate ester resin, or with a heat-curable resin film of at least one kind of heat-curable resin selected from the epoxy resin, bismaleimide resin and cyanate ester resin being laminated on such glass cloth.

The at least one kind of heat-curable resin selected from the epoxy resin, bismaleimide resin and cyanate ester resin is contained in an amount of preferably 10 to 200 parts by mass per 100 parts by mass of the glass cloth.

Further, it is preferred that the glass cloth be contained in the heat-curable resin-containing glass cloth prepreg by an amount of not smaller than 50% by mass, more preferably not smaller than 60% by mass. It is preferred that the heat-curable resin(s) be contained in the heat-curable resin-containing glass cloth prepreg by an amount of 5 to 50% by mass, more preferably 10 to 40% by mass.

As the heat-curable resin-containing glass cloth prepreg, there may be used one produced by a later-descried method, or a prepreg that is commercially available.

### <Heat-Curable Resin-Containing Carbon Nanotube Unwoven Cloth Prepreg>

The heat-curable resin-containing carbon nanotube unwoven cloth prepreg composing the glass cloth composite material of the present invention is one with the carbon nanotube unwoven cloth being impregnated with the heat-curable resin or with a heat-curable resin film being laminated on such carbon nanotube unwoven cloth; preferably one with the carbon nanotube unwoven cloth being impregnated with at least one kind of heat-curable resin selected from the epoxy resin, bismaleimide resin and cyanate ester resin, or with a heat-curable resin film of at least one kind of heat-curable resin selected from the epoxy resin, bismaleimide resin and cyanate ester resin being laminated on such carbon nanotube unwoven cloth.

It is preferred that the at least one kind of heat-curable resin selected from the epoxy resin, bismaleimide resin and cyanate ester resin be contained therein by an amount of 10 to 200 parts by mass per 100 parts by mass of the carbon nanotube unwoven cloth.

Further, it is preferred that the carbon nanotube unwoven cloth be contained in the heat-curable resin-containing carbon nanotube unwoven cloth prepreg by an amount of not smaller than 50% by mass, more preferably not smaller than 70% by mass. It is preferred that the heat-curable resin(s) be contained in the heat-curable resin-containing carbon nanotube unwoven cloth prepreg by an amount of 5 to 50% by mass, more preferably 10 to 30% by mass.

As the heat-curable resin-containing carbon nanotube unwoven cloth prepreg, there may be used one produced by a later-described method, or a commercially available product.

The glass cloth composite material of the present invention may further contain the following components as optional component

### <Thermoplastic Resin>

In addition to the heat-curable resins as indicated above, the glass cloth and/or the carbon nanotube unwoven cloth may further be impregnated with a thermoplastic resin, or a thermoplastic resin-containing heat-curable resin film may be laminated on the glass cloth and/or the carbon nanotube unwoven cloth. Typical examples of such thermoplastic resin include polyethylene, polypropylene, polyphenylene ether, polyetheretherketone, polyetherketone, polyethersulfone, and fluorine resin. Particularly, a solvent-soluble thermoplastic resin is preferable for impregnating it into the glass cloth and/or the carbon nanotube unwoven cloth.

If adding a thermoplastic resin, it is preferred that the thermoplastic resin be added in an amount of 0 to 50 parts by mass per 100 parts by mass of the heat-curable resin(s).

### <Coupling Agent>

In the present invention, a coupling agent may be used to improve a wettability and adhesion strength between the resin(s) and the glass cloth and/or carbon nanotube unwoven cloth.

Examples of such coupling agent may include silane coupling agents, and alkoxide-based compounds such as a titanium alkoxide compound and an aluminum alkoxide compound. Particularly, a silane coupling agent is preferred, and a preferable silane coupling agent may, for example, be a compound represented by a general formula Y—Si—X₃. Here, Y is an organic group having a functional group as typified by, for example, an amino group, an epoxy group, a hydroxyl group, a carboxyl group, a vinyl group, a methacryl group and a mercapto group; X is a hydrolyzable functional group as typified by an alkoxy group.

Specifically, as typical examples of such coupling agent, there may be listed γ-glycidoxypropyltrimethoxysilane, vinyltriethoxysilane, γ-aminopropyltriethoxysilane, γ-mercaptopropyltrimethoxysilane, γ-methacryloxypropyltrimethoxysilane, γ-aminobenzyltriethoxysilane, γ-aminophenyltriethoxysilane and the like.

It is appropriate that such coupling agent be used in an amount of 0.5 to 20 parts by mass per 100 parts by mass of the heat-curable resin(s).

Further, instead of using a coupling agent, for the purpose of improving the wettability to the heat-curable resin(s), it is also possible to treat the surfaces of the glass cloth and/or the carbon nanotube fibers with a diluted solution of the heat-curable resin(s).

### <Inorganic Material>

By filling the gaps between the intertwined fibers of the glass cloth or the carbon nanotube unwoven cloth that compose part of the present invention with a highly conductive inorganic material such as, for example, an inorganic powder, inorganic fibers or metal particles, not only electric conductivity can be further improved, but an electromagnetic wave shielding performance in a frequency band of 10 to 300 GHz can be improved as well.

Typical examples of such inorganic powder include carbon black, carbon nanotube, graphene, graphite, silica, zinc oxide, alumina, boron nitride, aluminum nitride, short carbon fibers, and short alumina fibers. Further, such metal particles may, for example, be of copper, iron, silver, gold or the like; and there may be added resin particles whose surfaces are coated with these metals.

Moreover, in order to further improve the thermal conductivity of the carbon nanotube unwoven cloth and/or the glass cloth, there may be used inorganic particles or fibers such as silica particles, zinc oxide particles, alumina particles, boron nitride particles, aluminum nitride particles, short carbon fibers, short alumina fibers, quartz fibers, and glass fibers. By using these materials, the thermal conductivity of the carbon nanotube unwoven cloth can be raised to 50 to 80 W/mK.

There are no particular restrictions on the particle size of the inorganic material; those having an average particle size of 0.5 to 30 μm are preferable in terms of heat dissipation and electric conductivity.

Here, the average particle size of the inorganic material is a D50 value measured by a laser diffraction method.

Further, if using carbon nanotubes as the inorganic material, it is preferred, for example, that the carbon nanotubes have an average diameter of not smaller than 0.5 nm, more preferably not smaller than 1 nm; and preferably not larger than 15 nm, more preferably not larger than 10 nm. The average diameter is a value obtained by measuring the diameters (outer diameters) of 100 randomly selected carbon nanotubes, using a transmission electron microscope.

The inorganic material may be directly dispersed into the glass cloth or the carbon nanotube unwoven cloth; or the glass cloth or the carbon nanotube unwoven cloth may be impregnated with a heat-curable resin(s) that already has the inorganic material dispersed therein.

The inorganic material may be dispersed into the glass cloth or the carbon nanotube unwoven cloth by any method. For example, there may be employed a method where the inorganic material is to be stuffed into the glass cloth or the carbon nanotube unwoven cloth by a pressing device or a laminator; a method where the inorganic material is to be dispersed in any solvent, followed by spraying the dispersion onto the glass cloth or the carbon nanotube unwoven cloth with a sprayer and then removing the solvent by drying; or even a combination of these methods.

Any solvent may be used as the solvent of the dispersion; a solvent with a high volatility is preferred, examples of which include water, an alcohol such as ethanol and isopropyl alcohol, acetone, toluene, a hydrocarbon-based solvent, and a silicone-based solvent. It is preferred that the concentration of the dispersion be 0.1 to 100 parts by mass per 100 parts by mass of the inorganic material.

If the inorganic material is to be dispersed into and immobilized in the glass cloth or the carbon nanotube unwoven cloth, an immobilization amount is preferably 0.01 to 100 parts by mass per 100 parts by mass of the glass cloth or the carbon nanotube unwoven cloth.

If the glass cloth or the carbon nanotube unwoven cloth is to be impregnated with a heat-curable resin(s) that already has the inorganic material dispersed therein, or if this heat-curable resin(s) is to be laminated thereon as a heat-curable resin film, the inorganic material is preferably in an amount of 5 to 60 parts by mass, more preferably 10 to 50 parts by mass, per 100 parts by mass of the heat-curable resin(s).

### <Production Method>

The glass cloth composite material of the present invention can be produced by any of:

a method where the heat-curable resin-containing carbon nanotube unwoven cloth prepreg that is impregnated with the heat-curable resin or has the heat-curable resin film laminated therein is at first produced, followed by laminating the heat-curable resin-containing carbon nanotube unwoven cloth prepreg and the glass cloth;

a method where the heat-curable resin-containing glass cloth prepreg that is impregnated with the heat-curable resin or has the heat-curable resin film laminated therein is at first produced, followed by laminating the heat-curable resin-containing glass cloth prepreg and the carbon nanotube unwoven cloth; or a method where the heat-curable resin-containing glass cloth prepreg and the heat-curable resin-containing carbon nanotube unwoven cloth prepreg are produced separately, followed by laminating these prepregs.

As a method for producing the heat-curable resin-containing glass cloth prepreg, there may be listed, for example, a wet method where the viscosity of the heat-curable resin is at first lowered by dissolving it in a solvent, followed by impregnating the glass cloths with such heat-curable resin; and a melt rolling method where the viscosity of the heat-curable resin is at first lowered by heating the heat-curable resin, followed by impregnating the glass cloths with such heat-curable resin.

As a method for producing the heat-curable resin-containing carbon nanotube unwoven cloth prepreg, there may be listed a wet method where the viscosity of the heat-curable resin is at first lowered by dissolving it in a solvent, followed by impregnating the carbon nanotube unwoven cloth with such heat-curable resin; and a melt rolling method where the viscosity of the heat-curable resin is at first lowered by heating the heat-curable resin, followed by impregnating the carbon nanotube unwoven cloth with such heat-curable resin.

Further, a varnish of the heat-curable resin may be turned into a film with the aid of a coater or the like so as to fabricate a heat-curable resin film, followed by laminating such heat-curable resin film on both surfaces of the glass cloth or the carbon nanotube unwoven cloth so as to obtain a prepreg.

In the wet method, a volatile solvent may preferably be used as a solvent, whereby after impregnating the glass cloth or the carbon nanotube unwoven cloth with the heat-curable resin, a prepreg impregnated with an uncured heat-curable resin can be fabricated by removing the solvent.

Examples of such solvent include anisole, cyclohexanone, tetralin, mesitylene, xylene, toluene, tetrahydrofuran (THF), dimethylformamide (DMF), dimethylsulfoxide (DMSO), and acetonitrile; the solvent shall not be limited to these solvents depending on the heat-curable resin(s). Any one kind of these solvents may be used alone, or two or more kinds of them may be used in combination. The solvent is preferably added in an amount of 5 to 95% by mass.

There will be negative impacts at the time of molding if the solvent remains in the prepreg, which may lead to a problem of, for example, deteriorating the work environment. Thus, the amount of the solvent remaining in the prepreg is not larger than 1% by mass, preferably not larger than 0.5% by mass. Although depending on the boiling point of the solvent used, a method for removing the solvent may preferably be a heat treatment performed at 80 to 150° C. for about 10 min to 1 hour; this heat treatment allows the solvent to be removed easily.

The melt rolling method has advantages in various aspects such as the fact that the method does not particularly require a solvent removal step whereby a relatively favorable work efficiency can be achieved. In the melt rolling method, the glass cloth or the carbon nanotube unwoven cloth is widened to a required width using a bar or the like, followed by placing and laminating the heat-curable resin that has been turned into a film on one or both surfaces of the glass cloth or the carbon nanotube unwoven cloth before conducting heating and pressurizing, thus obtaining a prepreg impregnated with an uncured heat-curable resin.

As for the glass cloth (heat-curable resin-containing glass cloth prepreg) and the carbon nanotube unwoven cloth (heat-curable resin-containing carbon nanotube unwoven cloth prepreg), they may be laminated in any number of pieces and in any order so long as there is one layer of each; particularly, if the heat-curable resin is contained in both the glass cloth and the carbon nanotube unwoven cloth, a ratio of [number of layers of heat-curable resin-containing glass cloth prepreg/number of layers of heat-curable resin-containing carbon nanotube unwoven cloth prepreg] in the glass cloth composite material is preferably 0.1 to 5.0, more preferably 1.0 to 3.0 in terms of exhibiting the electromagnetic shielding and impact properties.

By laminating the heat-curable resin-containing glass cloth prepreg(s) (or glass cloth) and the heat-curable resin-containing carbon nanotube unwoven cloth prepreg(s) (or carbon nanotube unwoven cloth(s)), and then carrying out molding via, for example, any one of the molding methods (1) to (4) shown below, there can be obtained a glass cloth composite material having a desired shape.

### (1) Press Molding

Method suitable for mass production, where the prepregs are to be laminated in a mold and cured by heating while applying a pressure thereto.

### (2) Autoclave Molding

Method where the prepregs are to be laminated in a forming mold, followed by placing a bagging film thereon so as to perform depressurization, and then curing the prepregs by heating in an autoclave while applying a pressure thereto.

### (3) Oven Molding

Method where the prepregs are to be laminated in a forming mold, followed by placing a bagging film thereon so as to perform depressurization, and then curing the prepregs by heating under vacuum pressure.

### (4) Sheet-Wrap Molding

Method where the prepregs are to be wrapped around a mandrel and taped, followed by curing the prepregs by heating before removing the mandrel.

As for a heat curing condition in the above molding methods, for example, the temperature is preferably 120 to 200° C., more preferably 140 to 180° C., and the time period is preferably in the range of 0.5 to 10 hr, more preferably 1 to 5 hr.

Further, as for a pressurizing condition in press molding, for example, the pressure is preferably in the range of 0.1 to 0.9 MPa, more preferably 0.2 to 0.5 MPa.

Various parts can be produced by processing the glass cloth composite material of the present invention via these molding methods.

Since the glass cloth composite material of the present invention is light and superior in electromagnetic wave-shielding property and impact resistance, it can be used in the bodies as well as structural members of automobile vehicles, drones, vessels, airplanes and so on. Further, the glass cloth composite material of the present invention is also suitable for use in members requiring an electromagnetic wave-shielding property, such as a storage container for an automobile vehicle battery or the like, a motor member, and a DC/DC convertor encapsulation material, which generate electromagnetic waves.

Moreover, the glass cloth composite material of the present invention can also be utilized as a member of or a storage container for a communication device operating at frequencies as high as or higher than those of millimeter waves, that requires an electromagnetic wave-shielding property and a heat resistance.

Since a carbon nanotube unwoven cloth easily produces heat as a result of applying a voltage to both ends thereof, the glass cloth composite material of the present invention can be used as a heating element for a broad range of purposes.

### WORKING EXAMPLES

The present invention is described in detail hereunder with reference to working examples; the present invention shall not be limited to the following working examples. Here, in the working examples, “parts” refers to “parts by mass.”

Materials used in the working and comparative examples of the present invention are as follows.

### (1) Bismaleimide Resin

### (A-1)

Bismaleimide resin represented by the following formula (SLK-3000 by Shin-Etsu Chemical Co., Ltd., number average molecular weight 5,200):

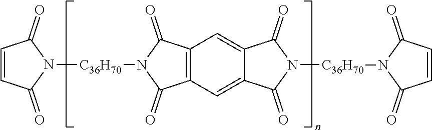

where n≈5 (Average value).

### (A-2)

Bismaleimide resin represented by the following formula (SLK-6895 by Shin-Etsu Chemical Co., Ltd., number average molecular weight 689):

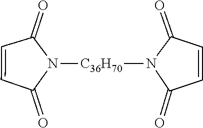

where C₃₆H₇₀ represents a dimer acid frame-derived hydrocarbon group.

### (2) Epoxy Resin

### (A-3)

Epoxy resin (ZX-1059 by NIPPON STEEL Chemical & Material Co., Ltd., a mixture of bisphenol A-type epoxy resin and bisphenol F-type epoxy resin)

### <Preparation of Resin Film>

### Resin Film (1)

A bismaleimide resin composition was prepared by mixing 100 parts by mass of the bismaleimide resin (A-1) and 1 part by mass of a curing catalyst (dicumylperoxide “PERCUMYL D” by NOF CORPORATION). A cyclohexanone was then added as a solvent so that a content of this bismaleimide resin composition would be 50% by mass in the solution obtained, the solution being a cyclohexanone solution (1) of the bismaleimide resin composition. A roller coater was then used to apply the cyclohexanone solution (1) of the bismaleimide resin composition to a PET film of a thickness of 38 μm that had been subjected to a mold release treatment, followed by performing drying at 100° C. for 10 min so as to prepare an uncured resin film (1) having a thickness of 30 μm.

### Resin Film (2)

A bismaleimide resin composition was prepared by adding 5 parts by mass of a carbon nanotube powder ZEONANO SG101 (by Zeon Nano Technology Co., Ltd.) to 100 parts by mass of a bismaleimide resin composition containing 100 parts by mass of the bismaleimide resin (A-2) and 1 part by mass of a curing catalyst (dicumylperoxide “PERCUMYL D” by NOF CORPORATION), and then by using a rotating and revolving mixer to mix them at 2,000 rpm for 5 min. A cyclohexanone solvent was then added so that a content of this bismaleimide resin composition would be 50% by mass in the solution obtained, the solution being a cyclohexanone solution (2) of the bismaleimide resin composition. A roller coater was then used to apply this solution to a PET film of a thickness of 38 μm that had been subjected to a mold release treatment, followed by performing drying at 100° C. for 10 min so as to obtain an uncured resin film (2) having a thickness of 30 μm.

### Resin Film (3)

An epoxy resin composition was prepared by mixing 100 parts by mass of the epoxy resin (A-3) and 38.3 parts by mass of an aromatic amine curing agent (KAYAHARD AA by Nippon Kayaku Co., Ltd; the amount of 38.3 parts by mass is an amount at which the equivalent of all the amino groups in the aromatic amine curing agent becomes 1.0 per 1 molar equivalent of the epoxy groups in the epoxy resin). Toluene was then added so that a content of this epoxy resin composition would be 50% by mass in the solution obtained, the solution being a toluene solution (1) of the epoxy resin composition.

### <Glass Cloth>

Woven fabrics made by plain weaving glass fibers, as specified by JIS R3413, were used.

### Glass Cloth (1)

T glass yarns (IPC name: E225) were used to fabricate a glass cloth (1) having a warp yarn density of 60 yarns/25 mm, a weft yarn density of 58 yarns/25 mm, a thickness of 95 μm and weight density of 104 g/m².

### Glass Cloth (2)

T glass yarns (IPC name: D450) were used to fabricate a glass cloth (2) having a warp yarn density of 60 yarns/25 mm, a weft yarn density of 60 yarns/25 mm, a thickness of 50 μm and weight density of 54 g/m².

### Glass Cloth (3)

Quartz glass yarns (IPC name: E225) were used to fabricate a glass cloth (3) having a warp yarn density of 60 yarns/25 mm, a weft yarn density of 58 yarns/25 mm, a thickness of 86 μm and weight density of 85.5 g/m².

### <Prepreg of Glass Cloth>

### Reference Example 1

A piece of the resin film (1) cut out into a size of 10 cm×10 cm and having a thickness of 30 μm and a weight of 0.3 g was placed on both surfaces of 1.04 g of the glass cloth (1) that had a thickness of 95 μm and was 10 cm-squared, followed by laminating them at 80° C. for 1 min, and then pressing them at 150° C. for 15 min, thereby obtaining a glass cloth-based prepreg (GC1).

### Reference Example 2

A glass cloth-based prepreg (GC2) was prepared in a similar manner as the reference example 1, except that instead of the glass cloth (1), there was used 0.54 g of the glass cloth (2) that had a thickness of 50 μm and was 10 cm-squared.

### Reference Example 3

A glass cloth-based prepreg (GC3) was prepared in a similar manner as the reference example 1, except that instead of the glass cloth (1), there was used 0.86 g of the glass cloth (3) that had a thickness of 86 μm and was 10 cm-squared.

### <Carbon Nanotube Unwoven Cloth>

### Unwoven Cloth (1)

CNTM30 (multi-walled carbon nanotube by Tortech Nano Fibers)
Thickness: 78 μm
Air permeability: 0.01 cm³/cm²·s
Specific resistance: 1.51E-03 (02·cm)

### Unwoven Cloth (2)

CNTM10 (multi-walled carbon nanotube by Tortech Nano Fibers)
Thickness: 32 μm
Air permeability: 0.04 cm³/cm²·s
Specific resistance: 2.22E-03 (Ω·cm)

### Unwoven Cloth (3)

Single-walled carbon nanotube unwoven cloth (by MEIJO NANO CARBON Co., Ltd.)
Thickness: 50 μm
Air permeability: 0.01 cm³/cm²·s
Specific resistance: 1.82E-04 (2·cm)

### Unwoven Cloth (4)

A carbon nanotube unwoven cloth (4) was obtained by dispersing 1 g of a single-walled carbon nanotube powder (ZEONANO SG101 by Zeon Nano Technology Co., Ltd., average diameter 3 nm) on both surfaces of 0.3 g of CNTM30 (unwoven cloth (1)). The single-walled carbon nanotube powder was immobilized in an amount of 0.03 g with respect to the 0.3 g of CNTM30.
Thickness: 72 μm
Air permeability: 0.01 cm³/cm²·s
Specific resistance: 3.0E-03 (02·cm)

### Unwoven Cloth (5)

A carbon nanotube unwoven cloth (5) composed of single-walled and multi-walled carbon nanotubes was prepared by immersing 0.3 g of CNTM30 (unwoven cloth (1)) in 20 g of a 0.2 wt % single-walled carbon nanotube solution (EC 1.5 P (NMP solution) by MEIJO NANO CARBON Co., Ltd.) at 25° C. for 30 min, and then performing drying at 200° C. for 5 min.
Thickness: 75 μm
Air permeability: 0.02 cm³/cm²·s
Apecific resistance: 2.4E-03 ((2·cm)

### <Prepreg of Carbon Nanotube Unwoven Cloth>

### Reference Example 4

A piece of the resin film (1) cut out into a size of 10 cm×10 cm and having a thickness of 30 μm and a weight of 0.3 g was placed on both surfaces of 0.23 g of the carbon nanotube unwoven cloth (1) that had a thickness of 78 μm and was 10 cm-squared, followed by laminating them at 80° C. for 1 min, and then pressing them at 150° C. for 15 min, thereby obtaining a carbon nanotube unwoven cloth-based prepreg (CNT1).

### Reference Example 5

A carbon nanotube unwoven cloth-based prepreg (CNT2) was prepared in a similar manner as the reference example 4, except that instead of the carbon nanotube unwoven cloth (1), there was used 0.10 g of the carbon nanotube unwoven cloth (2) that had a thickness of 32 μm and was 10 cm-squared.

### Reference Example 6

A carbon nanotube unwoven cloth-based prepreg (CNT3) was prepared in a similar manner as the reference example 4, except that instead of the carbon nanotube unwoven cloth (1), there was used 1.5 g of the carbon nanotube unwoven cloth (3) that had a thickness of 50 μm and was 10 cm-squared.

### Reference Example 7

A carbon nanotube unwoven cloth-based prepreg (CNT4) was prepared in a similar manner as the reference example 4, except that instead of the carbon nanotube unwoven cloth (1), there was used 0.22 g of the carbon nanotube unwoven cloth (4) that had a thickness of 72 μm and was 10 cm-squared.

### Reference Example 8

A carbon nanotube unwoven cloth-based prepreg (CNT5) was prepared in a similar manner as the reference example 4, except that instead of the carbon nanotube unwoven cloth (1), there was used 0.23 g of the carbon nanotube unwoven cloth (5) that had a thickness of 75 μm and was 10 cm-squared.

### Reference Example 9

A carbon nanotube unwoven cloth-based prepreg (CNT6) was prepared in a similar manner as the reference example 4, except that instead of the resin film (1), there were used the resin film (2).

### Reference Example 10

A carbon nanotube unwoven cloth-based prepreg (CNT7) was prepared by immersing the carbon nanotube unwoven cloth (1) in the toluene solution (1) of the epoxy resin composition that had been prepared as above, and then drying the same at 120° C. for 30 min.

A micrometer was used to measure the thickness of each of the carbon nanotube unwoven cloth-based prepregs CNT1 to CNT8, and an eddy-current method resistance measurement instrument (by NAPSON CORPORATION) was used to measure the apparent resistivity of each of these prepregs. The results thereof are shown in Table 1.

TABLE 1

| | | Reference | Reference | Reference | Reference | Reference | Reference | Reference |
|---|---|---|---|---|---|---|---|---|
| Prepreg material | | example 4 | example 5 | example 6 | example 7 | example 8 | example 9 | example 10 |
| Carbon nanotube unwoven cloth prepreg No. | | CNT1 | CNT2 | CNT3 | CNT4 | CNT5 | CNT6 | CNT7 |
| Carbon nanotube unwoven cloth | CNTM30 | ✓ | | | ✓ | ✓ | ✓ | ✓ |
| | CNTM10 | | ✓ | | | | | |
| CNT unwoven cloth by MEIJO NANO CARBON | | | | ✓ | | | | |
| Carbon nanotube powder (part by mass) | SG101 | | | | ✓ | | ✓ | |
| Carbon nanotube solution | | | | | | ✓ | | |
| Bismaleimide resin film No. | | 1 | 1 | 1 | 1 | | 2 | |
| Epoxy resin composition impregnation | | | | | | | | ✓ |

| | | | | | | | |
|---|---|---|---|---|---|---|---|
| Thickness (μm) | 135 | 90 | 105 | 136 | 138 | 135 | 105 |
| Apparent resistivity (Ω · cm) | 3.30E−03 | 4.20E−03 | 7.10E−04 | 3.00E−03 | 2.40E−03 | 2.60E−03 | 3.50E−03 |

Properties of the sheets produced in the working and comparative examples were measured and evaluated by the following methods, and the results thereof are shown in Tables 2 and 3.

Thickness: Sheet thickness was measured by a micrometer.

Specific Resistance: Specific resistance of the sheet was measured by an eddy-current method resistance measurement instrument (by NAPSON CORPORATION) Electromagnetic Wave Shielding Effect

Electromagnetic wave shielding effect (SE) is defined by the following formula:

$$S E = R + A = 50 + 10 {log ( {ρ}_{B} f )}^{- 1} + 1.7 {t ( \frac{f}{{p}_{B}} )}^{\frac{1}{2}}$$

where R is the attenuation by reflection in dB, A is the attenuation by absorption in dB, ρ_{B} is the volume specific electric resistance (Ω-cm), f is the frequency (MHz) and t is the sample thickness (cm).

A large SE value at 10 GHz indicates an excellent electromagnetic wave shielding effect (SE) where a shielding effect is exhibited in a wide frequency range from low to high frequencies.

### Impact Strength

An impact strength was measured via a puncture impact test in accordance with a measurement method: JIS K7211.

In the beginning, two layers of the glass cloth prepreg (1) were laminated together and then heated at 200° C. for 30 min so as to be cured, thereby fabricating a 400 μm-thick cured product of the glass cloth prepreg (1). An impact test value I of such cured product of the glass cloth prepreg (1) was measured.

Next, an impact test value II of each sheet produced in the working and comparative examples was measured.

Based on these impact test values I and II, a strength ratio between the two was calculated via a formula: strength ratio of impact test value=impact test value II/impact test value I.

### Working Example 1

A piece of the glass cloth prepreg (GC1) produced in the reference example 1 was placed on both the upper and lower surfaces of the carbon nanotube unwoven cloth prepreg (CNT1) produced in the reference example 4 so as to laminate them in three layers. A hot press set to a temperature of 200° C. was then used to pressurize them at a pressure of 7.0 MPa and cure the laminate for 30 min, thereby obtaining a three-layered glass cloth composite material (glass cloth composite sheet 1).

The electromagnetic wave shielding effectiveness and impact test strength ratio of this glass cloth composite sheet 1 are shown in Table 2.

### Working Example 2

A piece of the carbon nanotube unwoven cloth prepreg (CNT1) produced in the reference example 4 was placed on both the upper and lower surfaces of the glass cloth prepreg (GC1) of the reference example 1 so as to laminate them in three layers, followed by further placing a piece of the glass cloth prepreg (GC1) on both the upper most and lower most surfaces of the three-layered laminate so as to obtain a five-layered laminate. A hot press set to a temperature of 200° C. was then used to pressurize the laminate at a pressure of 7.0 MPa and cure it for 30 min, thereby obtaining a five-layered glass cloth composite material (glass cloth composite sheet 2).

The electromagnetic wave shielding effectiveness and impact test strength ratio of this glass cloth composite sheet 2 are shown in Table 2.

### Working Example 3

A piece of the carbon nanotube unwoven cloth prepreg (CNT1) produced in the reference example 4 was placed on the upper surfaces of the glass cloth prepreg (GC1) so as to laminate them in two layers. A hot press set to a temperature of 200° C. was then used to pressurize them at a pressure of 7.0 MPa and cure the laminate for 30 min, thereby obtaining a two-layered glass cloth composite material (glass cloth composite sheet 3).

The electromagnetic wave shielding effectiveness and impact test strength ratio of this glass cloth composite sheet 3 are shown in Table 2.

### Working Example 4

A piece of the carbon nanotube unwoven cloth prepreg (CNT1) of the reference example 4 was placed on both the upper and lower surfaces of the glass cloth prepreg (GC1) produced in the reference example 1 so as to laminate them in three layers. A hot press set to a temperature of 200° C. was then used to pressurize them at a pressure of 7.0 MPa and cure the laminate for 30 min, thereby obtaining a three-layered glass cloth composite material (glass cloth composite sheet 4).

The electromagnetic wave shielding effectiveness and impact test strength ratio of this glass cloth composite sheet 4 are shown in Table 2.

### Working Example 5

A piece of the glass cloth prepreg (GC2) of the reference example 2 was placed on both the upper and lower surfaces of the carbon nanotube unwoven cloth prepreg (CNT1) produced in the reference example 4 so as to laminate them in three layers. A hot press set to a temperature of 200° C. was then used to pressurize them at a pressure of 7.0 MPa and cure the laminate for 30 min, thereby obtaining a three-layered glass cloth composite material (glass cloth composite sheet 5).

The electromagnetic wave shielding effectiveness and impact test strength ratio of this glass cloth composite sheet 5 are shown in Table 2.

### Working Example 6

A piece of the glass cloth prepreg (GC3) of the reference example 3 was placed on both the upper and lower surfaces of the carbon nanotube unwoven cloth prepreg (CNT1) produced in the reference example 4 so as to laminate them in three layers. A hot press set to a temperature of 200° C. was then used to pressurize them at a pressure of 7.0 MPa and cure the laminate for 30 min, thereby obtaining a three-layered glass cloth composite material (glass cloth composite sheet 6).

The electromagnetic wave shielding effectiveness and impact test strength ratio of this glass cloth composite sheet 6 are shown in Table 2.

### Working Example 7

A piece of the glass cloth prepreg (GC1) of the reference example 1 was placed on both the upper and lower surfaces of the carbon nanotube unwoven cloth prepreg (CNT2) produced in the reference example 5 so as to laminate them in three layers. A hot press set to a temperature of 200° C. was then used to pressurize them at a pressure of 7.0 MPa and cure the laminate for 30 min, thereby obtaining a three-layered glass cloth composite material (glass cloth composite sheet 7).

The electromagnetic wave shielding effectiveness and impact test strength ratio of this glass cloth composite sheet 7 are shown in Table 2.

### Working Example 8

As is the case in the working example 1, a piece of the glass cloth prepreg (GC1) of the reference example 1 was placed on both the upper and lower surfaces of the carbon nanotube unwoven cloth prepreg (CNT3) produced in the reference example 6 so as to laminate them in three layers. A hot press set to a temperature of 200° C. was then used to pressurize them at a pressure of 7.0 MPa and cure the laminate for 30 min, thereby obtaining a three-layered glass cloth composite material (glass cloth composite sheet 8).

The electromagnetic wave shielding effectiveness and impact test strength ratio of this glass cloth composite sheet 8 are shown in Table 2.

### Working Examples 9 to 12

Three-layered glass cloth composite materials (glass cloth composite sheets 9 to 12) were obtained in a similar manner as the working example 1 by performing pressurization at a pressure of 7.0 MPa and curing for 30 min with a hot press set to a temperature of 200° C., except that instead of the carbon nanotube unwoven cloth prepreg (CNT1) produced in the reference example 4, there were respectively used the carbon nanotube unwoven cloth prepregs (CNT4 to CNT7) produced in the reference examples 7 to 10.

The electromagnetic wave shielding effectiveness and impact test strength ratios of these glass cloth composite sheets 9 to 12 are shown in Table 2.

### Working Example 13

A piece of the carbon nanotube unwoven cloth (1) was placed on the upper surface of the glass cloth prepreg (GC1) so as to laminate them in two layers. A hot press set to a temperature of 200° C. was then used to pressurize them at a pressure of 7.0 MPa and cure the laminate for 30 min, thereby obtaining a two-layered glass cloth composite material (glass cloth composite sheet 13).

The electromagnetic wave shielding effectiveness and impact test strength ratio of this glass cloth composite sheet 13 are shown in Table 2.

### Comparative Example 1

The carbon nanotube unwoven cloth prepreg (CNT1) produced in the reference example 4 was heated at 200° C. for 30 min so as to be cured, thereby fabricating a sheet-shaped cured product (sheet 14) having a thickness of 135 μm.

The electromagnetic wave shielding effect and impact test strength ratio of this sheet 14 are shown in Table 3.

### Comparative Example 2

Two layers of the carbon nanotube unwoven cloth prepreg (CNT1) produced in the reference example 4 were laminated together and then heated at 200° C. for 30 min so as to be cured, thereby fabricating a sheet-shaped cured product (sheet 15) having a thickness of 270 μm.

The electromagnetic wave shielding effect and impact test strength ratio of this sheet 15 are shown in Table 3.

### Comparative Example 3

The carbon nanotube unwoven cloth (1) was treated as a sheet 16. The electromagnetic wave shielding effectiveness and impact test strength ratio of this sheet 16 are shown in Table 3.

### Comparative Example 4

The carbon nanotube unwoven cloth (2) was treated as a sheet 17.

The electromagnetic wave shielding effectiveness and impact test strength ratio of this sheet 17 are shown in Table 3.

| | | Working | Working | Working | Working | Working | Working | Working |
|---|---|---|---|---|---|---|---|---|
| | | example | example | example | example | example | example | example |
| | | 1 | 2 | 3 | 4 | 5 | 6 | 7 |
| Glass cloth composite sheet No. | | 1 | 2 | 3 | 4 | 5 | 6 | 7 |
| Glass cloth prepreg No. | | GC1 | GC1 | GC1 | GC1 | GC2 | GC3 | GC |
| Carbon nanotube umvoven cloth prepreg | | CNT1 | CNT1 | CONT1 | CNT1 | CNT1 | CNT1 | CNT2 |
| No. | | | | | | | | |
| Number of laminated layers of preprogs | | 1 | 2 | 1 | 2 | 1 | 1 | 1 |
| and/or carbon nanotube unwoven cloth | | | | | | | | |
| Number of laminated layers of prepregs | | 3 | 5 | 2 | 3 | 3 | 3 | 3 |
| Property of glass | Thickness (cm) | 0.040 | 0.065 | 0.027 | 0.030 | 0.031 | 0.038 | 0.036 |
| cloth composite | Specific resistance | 3.80E−03 | 2.80E−03 | 3.80E−03 | 2.80E−03 | 3.50E−03 | 3.90E−03 | 4.60E−03 |
| sheet | (Ω · cm) | | | | | | | |
| | Shielding effectiveness | 73 | 90 | 72 | 88 | 74 | 71 | 52 |
| | in dB at 10 GH | | | | | | | |
| | Strength ratio via | 2.2 | 3.9 | 1.7 | 2.6 | 1.5 | 1.8 | 1.6 |
| | impact test | | | | | | | |

| | | Working | Working | Working | Working | Working | Working |
|---|---|---|---|---|---|---|---|
| | | example | example | example | example | example | example |
| | | 8 | 9 | 10 | 11 | 12 | 13 |
| Glass cloth composite sheet No. | | 8 | 9 | 10 | 11 | 12 | 13 |
| Glass cloth prepreg No. | | GC1 | GC1 | GC1 | GC1 | GC1 | GC1 |
| Carbon nanotube umvoven cloth prepreg | | CNT3 | CNT4 | CNT5 | CNT6 | CNT7 | *(See the |
| No. | | | | | | | footnote placed |
| | | | | | | | immediately |
| | | | | | | | below the |
| | | | | | | | table) |
| Number of laminated layers of preprogs | | 1 | 1 | 1 | 1 | 1 | 1 |
| and/or carbon nanotube unwoven cloth | | | | | | | |
| Number of laminated layers of prepregs | | 3 | 3 | 3 | 3 | 3 | 2 |
| Property of glass | Thickness (cm) | 0.030 | 0.041 | 0.041 | 0.040 | 0.036 | 0.021 |
| cloth composite | Specific resistance | 9.00E−04 | 3.60E−03 | 3.30E−03 | 3.70E−03 | 3.70E−03 | 3.80E−03 |
| sheet | (Ω · cm) | | | | | | |
| | Shielding effectiveness | 120 | 75 | 79 | 73 | 73 | 71 |
| | in dB at 10 GH | | | | | | |
| | Strength ratio via | 2.1 | 1.7 | 2 | 1.6 | 2.2 | 16 |
| | impact test | | | | | | |

*Carbon nanotube unwoven cloth was solely used instead of the carbon nanotube unwoven cloth prepreg

TABLE 3

| | | Comparative | Comparative | Comparative | Comparative |
|---|---|---|---|---|---|
| | | example 1 | example 2 | example 3 | example 4 |
| Electromagnetic wave shielding sheet No. | | 14 | 15 | 16 | 17 |
| Carbon nanotube unwoven cloth prepreg (CNT 1) | | ✓ | ✓ | | |
| Carbon nanotube unwoven cloth (1) | | | | ✓ | |
| Carbon nanotube unwoven cloth (2) | | | | | ✓ |
| Number of laminated layers of prepregs | | 1 | 2 | 1 | 1 |
| Property of carbon nanotube | Shielding effectiveness in dB | 72 | 110 | 70 | 50 |
| unwoven cloth sheet | at 10 GH | | | | |
| | Strength ratio via impact test | 1.0 | 1.2 | 0.8 | 0.4 |

As shown in the working examples 1 to 13, the impact test strength ratios of the glass cloth sheets of the working examples that are composed of a single layer of the carbon nanotube unwoven cloth prepreg to the sheet composed of the carbon nanotube unwoven cloth prepreg of the comparative example 1 were all 1.0 or larger. Further, the impact test strength ratios of the glass cloth sheets of the working examples 2 and 4, composed of two layers of the carbon nanotube unwoven cloth prepreg, were also all 1.0 or larger compared to the sheet of the comparative example 2. These results clearly indicate that the glass cloth composite sheets are superior in impact resistance. In addition, the glass cloth composite sheets of the working examples 1 to 13 were also comparable or superior to those of the comparative examples 1 and 2 in terms of electromagnetic wave shielding effect at 10 GHz.

As shown in the above, according to the glass cloth composite material of the present invention, although a sheet composed only of glass cloth has no electromagnetic wave shielding effect, the sheet can be combined with a carbon nanotube unwoven cloth to form a highly-reliable electromagnetic wave shielding sheet having electromagnetic wave shielding effect and an improved impact strength.

### INDUSTRIAL APPLICABILITY

Since the glass cloth composite material of the present invention has an excellent electromagnetic wave shielding effect and strength, it is suitable for use in high-speed and high-capacity communication devices, and is suitable for in-vehicle uses.

What is claimed is:

1. A glass cloth composite material comprising:
one or more glass cloth layers; and
one or more carbon nanotube unwoven cloth layers,
wherein at least one of the glass cloth and carbon nanotube unwoven cloth layers in the glass cloth composite material is impregnated with a heat-curable resin or has a heat-curable resin film laminated thereon.

2. The glass cloth composite material according to claim 1, comprising:
one or more layers of a heat-curable resin-containing glass cloth prepreg
with a glass cloth being impregnated with a heat-curable resin or
with a heat-curable resin film being laminated on a glass cloth; and
one or more layers of a heat-curable resin-containing carbon nanotube unwoven cloth prepreg
with a carbon nanotube unwoven cloth being impregnated with a heat-curable resin or
with a heat-curable resin film being laminated on a carbon nanotube unwoven cloth.

3. The glass cloth composite material according to claim 2, wherein a ratio of [number of layers of heat-curable resin-containing glass cloth prepreg/number of layers of heat-curable resin-containing carbon nanotube unwoven cloth prepreg] in the glass cloth composite material is 0.1 to 5.0.

4. The glass cloth composite material according to claim 1, wherein the carbon nanotube unwoven cloth is an unwoven cloth composed of multi-walled carbon nanotubes alone, single-walled carbon nanotubes alone, or a mixture of multi-walled carbon nanotubes and single-walled carbon nanotubes.

5. The glass cloth composite material according to claim 1, wherein the carbon nanotube unwoven cloth is a carbon nanotube unwoven cloth with a multi-walled carbon nanotube and a single-walled carbon nanotube being laminated together.

6. The glass cloth composite material according to claim 1, wherein the carbon nanotube unwoven cloth has a thickness of not larger than 1 mm, an air permeability of not larger than 0.5 cm³/cm²·s, and a specific resistance of not larger than 0.005 Ω·cm.
